(19) United States
(12) Patent Application Publication
(10) Pub. No.: US 2024/0217813 A1
(43) Pub. Date: Jul. 4, 2024

(54) Thixotropically Molded Product, Thixotropic Molding Material, And Method Of Producing Thixotropic Molding Material

(71) Applicant: SEIKO EPSON CORPORATION, Tokyo (JP)

(72) Inventors: Yasutoshi HIDESHIMA, Matsumoto (JP); Shunsuke UCHIZONO, Shiojiri (JP); Setsuya IWASHITA, Nirasaki (JP); Fumiya MAEDA, Matsumoto (JP); Koichi OZAKI, Okayama (JP); Tadao FUKUTA, Kurashiki (JP)

(21) Appl. No.: 18/397,631

(22) Filed: Dec. 27, 2023

(30) Foreign Application Priority Data
Dec. 28, 2022 (JP) 2022-211893

(51) Int. Cl. C01B 3/08; C01B 5/00; C01B 33/06; C01B 33/113; C01D 1/02; C01G 3/02

(52) U.S. Cl. CPC C01B 3/08; C01B 5/00; C01B 33/06; C01B 33/113; C01D 1/02; C01G 3/02; C01P 2004/61

(57) ABSTRACT

A thixotropically molded product that generates hydrogen by contact with an aqueous solution includes: a matrix portion containing Mg as a main component; and a first particle portion dispersed in the matrix portion and containing, as a main component, any one of Fe, Ni, Co, Cu, and a compound containing at least one of the elements. An average particle diameter of the first particle portion in a cross section is 30.0 μm or less, and an area fraction of the first particle portion in the cross section is 0.5% or more and 20.0% or less.

The present application is based on, and claims priority from JP Application Serial Number 2022-211893, filed Dec. 28, 2022, the disclosure of which is hereby incorporated by reference herein in its entirety.

### BACKGROUND

### 1. Technical Field

The present disclosure relates to a thixotropically molded product, a thixotropic molding material, and a method of producing a thixotropic molding material.

### 2. Related Art

Magnesium generates hydrogen by a corrosion reaction due to contact with an aqueous solution. Therefore, development of a hydrogen production method using magnesium is advanced.

For example, JP-A-2020-132509 discloses method in which metal magnesium grains are confined in a reactant, and stirring or vibration is applied by water passing through the reactant, causing grain clusters of the metal magnesium grains to collide with each other, thereby continuously exposing metal surfaces of the metal magnesium grains to generate hydrogen. According to the method, a magnesium hydroxide layer generated by a reaction between surfaces of the metal magnesium grains and water can be broken and separated, and hydrogen can be efficiently extracted.

In the method described in JP-A-2020-132509, it is necessary to reliably cause collision and abrasion of the grain clusters of the metal magnesium grains. However, since magnesium is a metal with a small specific gravity, it is not possible to give sufficient energy to the collision and the abrasion of the grain clusters, and the magnesium hydroxide layer cannot be sufficiently broken. Therefore, there is still room for improvement in efficient generation of hydrogen.

### SUMMARY

A thixotropically molded product according to an application example of the present disclosure is a thixotropically molded product that generates hydrogen by contact with an aqueous solution. The thixotropically molded product includes: a matrix portion containing Mg as a main component; and a first particle portion dispersed in the matrix portion and containing, as a main component, any one of Fe, Ni, Co, Cu, and a compound containing at least one of the elements. An average particle diameter of the first particle portion in a cross section is 30.0 μm or less, and an area fraction of the first particle portion in the cross section is 0.5% or more and 20.0% or less.

A thixotropic molding material according to an application example of the present disclosure is a thixotropic molding material used for production of a thixotropically molded product that generates hydrogen by contact with an aqueous solution. The thixotropic molding material includes: a metal body containing Mg as a main component; metal-containing particles adhering to a surface of the metal body and containing, as a main component, any one of Fe, Ni, Co, Cu, and a compound containing at least one of the elements; and a bonding portion interposed between the metal body and the metal-containing particles. An average particle diameter of the metal-containing particles is 30 μm or less, and a ratio of the metal-containing particles to a total of the metal body and the metal-containing particles is 0.5 mass % or more and 30.0 mass % or less.

A method of producing a thixotropic molding material according to an application example of the present disclosure is a method of producing a thixotropic molding material used for production of a thixotropically molded product that generates hydrogen by contact with an aqueous solution. The method includes: a preparation step of preparing a mixture containing a metal body containing Mg as a main component, metal-containing particles containing, as a main component, any one of Fe, Ni, Co, Cu, and a compound containing at least one of the elements, a binder, and a dispersion medium; a stirring step of stirring the mixture; and a drying step of adhering the metal-containing particles to a surface of the metal body via the binder by removing at least a part of the dispersion medium from the stirred mixture. An average particle diameter of the metal-containing particles is 30 μm or less, and in the mixture, a ratio of the metal-containing particles to a total of the metal body and the metal-containing particles is 0.5 mass % or more and 30.0 mass % or less.

### BRIEF DESCRIPTION OF THE DRAWINGS

FIG. 1 is a cross-sectional view showing an example of an injection molding machine used in a thixotropic molding method.

FIG. 2 is a cross-sectional view schematically showing a thixotropic molding material according to a first embodiment.

FIG. 3 is a partially enlarged view of FIG. 2.

FIG. 4 is a step diagram showing a method of producing a thixotropic molding material according to a second embodiment.

FIG. 5 is a partial cross-sectional view schematically showing a thixotropically molded product according to a third embodiment.

### DESCRIPTION OF EMBODIMENTS

Hereinafter, a thixotropically molded product, a thixotropic molding material, and a method of producing a thixotropic molding material according to the present disclosure will be described in detail based on embodiments shown in the accompanying drawings.

### 1. Thixotropic Molding Method

First, an example of a thixotropic molding method of producing a thixotropically molded product will be described.

The thixotropic molding method is a molding method in which a pellet-shaped or chip-shaped raw material is heated in a cylinder to bring the material into a solid-liquid coexistence state in which a liquid phase and a solid phase coexist, then thixotropy is developed by rotation of a screw, and the obtained semi-solidified product is injected into a mold. According to such a thixotropic molding method, since fluidity of the semi-solidified product is enhanced by heating and shearing, even complex shapes can be efficiently formed as compared with, for example, a die casting method.

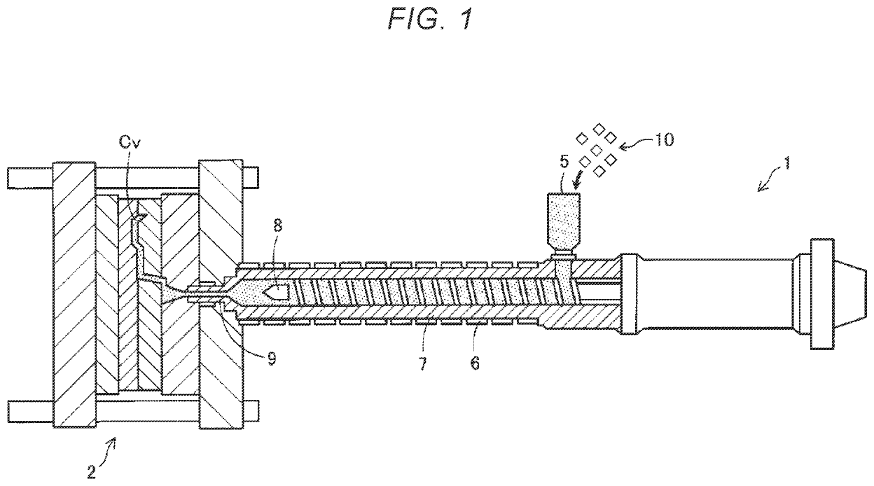

FIG. 1 is a cross-sectional view showing an example of an injection molding machine 1 used for the thixotropic molding method.

As shown in FIG. 1, the injection molding machine 1 includes a mold 2, a hopper 5, a heater 6, a heating cylinder 7, a screw 8, and a nozzle 9. A cavity Cv is formed in the mold 2. When a thixotropic molding material 10 is charged into the hopper 5, the thixotropic molding material 10 is supplied to the heating cylinder 7. The thixotropic molding material 10 supplied to the heating cylinder 7 is heated by the heater 6 and conveyed while being sheared by the screw 8. Accordingly, the thixotropic molding material 10 is semi-melted and slurried. The obtained slurry is injected into the cavity Cv in the mold 2 through the nozzle 9 without being exposed to the atmosphere. Then, the slurry injected into the cavity Cv is cooled to obtain a thixotropically molded product.

A material containing magnesium as a main component is used as the thixotropic molding material 10. The hopper 5 may be charged with other materials together with the thixotropic molding material 10.

### 2. First Embodiment

Next, a thixotropic molding material according to a first embodiment will be described.

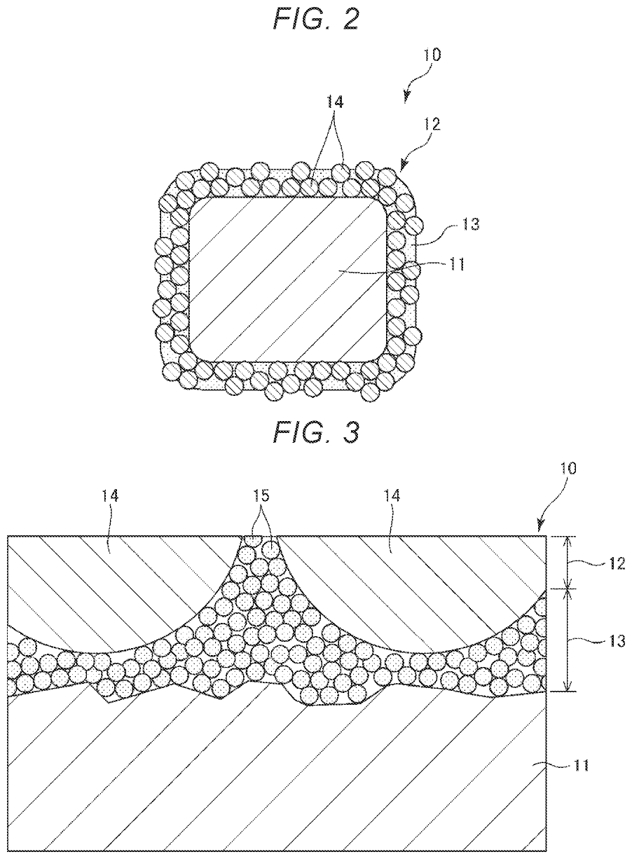

FIG. 2 is a cross-sectional view schematically showing the thixotropic molding material 10 according to the first embodiment. FIG. 3 is a partially enlarged view of FIG. 2.

The thixotropic molding material 10 shown in FIG. 2 includes a chip-shaped metal body 11, a coating portion 12 provided on a surface of the metal body 11, and a bonding portion 13 interposed between the metal body 11 and the coating portion 12.

The metal body 11 contains Mg as a main component. As shown in FIG. 2, the coating portion 12 includes a plurality of metal-containing particles 14. The metal-containing particles 14 are provided on the surface of the metal body 11. The metal-containing particles 14 contain, as a main component, any one of Fe, Ni, Co, Cu, and a compound containing at least one of the elements. These main components are components having a low cathode overvoltage when dispersed in a thixotropically molded product having a magnesium alloy as a matrix portion, and thus contribute to promotion of corrosion of the thixotropically molded product. In the present specification, these main components are referred to as “corrosion-promoting components”.

The bonding portion 13 penetrates between the metal body 11 and the metal-containing particles 14 and between the metal-containing particles 14 to bond them. In the embodiment, as shown in FIG. 3, the bonding portion 13 includes a plurality of interposed particles 15.

By performing thixotropic molding using the thixotropic molding material 10 having the bonding portion 13, the metal-containing particles 14 are prevented from falling off. Therefore, a semi-molten material of the metal body 11 and the metal-containing particles 14 are likely to be uniformly mixed in the heating cylinder 7. Accordingly, the metal-containing particles 14 are uniformly dispersed in the semi-molten material. As a result, it is possible to produce a thixotropically molded product in which the corrosion-promoting component is uniformly distributed in the matrix portion.

The metal-containing particles 14 have a high corrosion-promoting function derived from the corrosion-promoting component. The corrosion-promoting function is a function of promoting corrosion of magnesium in the matrix portion in the thixotropically molded product when the thixotropically molded product is brought into contact with an aqueous solution, and generating hydrogen for a longer period of time as compared with a case in which the corrosion-promoting component is not contained. As a principle of the function, for example, a local cell is formed between the corrosion-promoting component and the matrix portion. When magnesium is brought into contact with the aqueous solution, magnesium is converted into magnesium hydroxide. Since the magnesium hydroxide covers a surface of the thixotropically molded product, there is a problem in the related art that chances of contact between magnesium and the aqueous solution are reduced and hydrogen generation is inhibited.

On the other hand, since the corrosion-promoting component is uniformly dispersed in the thixotropically molded product containing the corrosion-promoting component, the above-described local cell is evenly formed on the entire body without bias. Therefore, there is less space and time for magnesium hydroxide to be produced, and as a result, corrosion progresses at a high rate. Therefore, the thixotropically molded product produced using the thixotropic molding material 10 according to the embodiment can efficiently generate hydrogen.

Since the metal-containing particles 14 are uniformly dispersed, it is possible to inhibit enlargement of Mg crystals precipitated in a process of solidification during the thixotropic molding. Accordingly, refinement of the Mg crystals can be achieved, and a movement of dislocation can be prevented. As a result, in the thixotropically molded product produced using the thixotropic molding material 10, specific strength derived from magnesium can be further enhanced, and surface hardness can be enhanced. Accordingly, it is possible to obtain a thixotropically molded product which is less likely to be chipped or cracked even when handled somewhat roughly, and which has good handleability.

The interposed particles 15 act to enhance wettability between the metal-containing particles 14 and the semi-molten material of the metal body 11 during the thixotropic molding. Accordingly, in the produced thixotropically molded product, affinity and adhesion between a site derived from the metal-containing particles 14 and a site derived from the metal body 11 can be enhanced. As a result, in the thixotropically molded product, a movement of electrons easily occurs between both sites, and thus corrosion accompanying the formation of the local cell can be further promoted.

### 2.1. Metal Body

The metal body 11 is, for example, a section obtained by machining or cutting an Mg-based alloy cast with a mold or the like. A method of producing the metal body 11 is not limited thereto.

A material containing Mg as a main component is used as a constituent material of the metal body 11. Containing Mg as a main component refers to that, when elemental analysis is performed on the metal body 11, a content of Mg is the highest in terms of atomic ratio. For the elemental analysis, for example, a qualitative and quantitative analysis based on an energy dispersive X-ray spectroscopy (EDX) is used. The content of Mg in the metal body 11 may be higher than that of other elements, and is preferably more than 50 atomic %, more preferably 70 atomic % or more, and still more preferably 80 atomic % or more.

The metal body 11 may contain various additive components other than Mg. Examples of the additive components include lithium, beryllium, calcium, aluminum, silicon, manganese, iron, nickel, copper, zinc, strontium, yttrium, zirconium, silver, tin, gold, and rare earth elements, and one or a mixture of two or more of these components is used. Examples of the rare earth elements include cerium.

In particular, the additive component preferably contains at least one of aluminum and zinc, and more preferably both contains aluminum and zinc. Accordingly, a melting point of the thixotropic molding material 10 decreases, and fluidity of the semi-solidified product during the thixotropic molding is improved. As a result, moldability during the thixotropic molding is enhanced.

A content of aluminum in the metal body 11 is, for example, preferably 5.0 mass % or more and 13.0 mass % or less, and more preferably 7.0 mass % or more and 11.0 mass % or less. A content of zinc in the metal body 11 is, for example, preferably 0.3 mass % or more and 3.0 mass % or less, and more preferably 0.5 mass % or more and 2.0 mass % or less.

In addition to aluminum and zinc, the additive component may contain at least one selected from the group consisting of silicon, manganese, yttrium, strontium, and rare earth elements.

A composition of the metal body 11 may be a composition of a magnesium alloy defined in various standards. Examples of such a magnesium alloy include AZ91A, AZ91B, AZ91D, AM60A, AM60B, AS41A, AZ31, AZ31B, AZ61A, AZ63A, AZ80A, AZ91C, AZ91E, AZ92A, AM100A, ZK51A, ZK60A, ZK61A, EZ33A, QE22A, ZE41A, M1A, WE54A, and WE43B of the American Society for Testing and Materials (ASTM) standard. Among these, AZ91A, AZ91B, or AZ91D are preferably used.

The additive components may be present in a form of a simple substance, an alloy, an oxide, an intermetallic compound, and the like in the metal body 11. The additive components may be segregated or uniformly dispersed in a crystal grain boundary of a metal structure such as Mg or an Mg alloy in the metal body 11.

An average particle diameter of the metal body 11 is not particularly limited, and is preferably 0.5 mm or more, and more preferably 1.5 mm or more and 10.0 mm or less. By setting the average particle diameter within the above range, generation of bridges and the like in the heating cylinder 7 of the injection molding machine 1 can be prevented.

The average particle diameter of the metal body 11 is an average value of diameters of circles having an area same as a projected area of the metal body 11. The average value is calculated based on 100 or more randomly selected metal bodies 11.

An average aspect ratio of the metal body 11 is preferably 10.0 or less, and more preferably 5.0 or less. In the metal body 11 having such an average aspect ratio, a filling property in the heating cylinder 7 is enhanced and temperature uniformity during heating is improved. As a result, thixotropically molded product having high mechanical properties and high dimensional accuracy can be obtained.

The average aspect ratio of the metal body 11 is an average value of aspect ratios calculated from major axis/minor axis in a projection image of the metal body 11. The average value is calculated based on 100 or more randomly selected metal bodies 11. The major axis is a maximum length that can be taken in the projection image, and the minor axis is a maximum length in a direction orthogonal to the major axis.

The metal body 11 may be subjected to any surface treatment as necessary. Examples of the surface treatment include a plasma treatment, a corona treatment, an ozone treatment, an ultraviolet irradiation treatment, and a roughening treatment.

### 2.2. Coating Portion

The coating portion 12 includes the plurality of metal-containing particles 14. In the embodiment, as shown in FIG. 2, the plurality of metal-containing particles 14 are distributed to cover the surface of the metal body 11, thereby forming the coating portion 12. The coating portion 12 preferably covers the entire surface of the metal body 11, or may cover only a part of the surface.

The metal-containing particles 14 are dispersed in the semi-molten material when subjected to the thixotropic molding. The metal-containing particles 14 are less likely to vaporize during the thixotropic molding, and can be prevented from causing molding defects.

The metal-containing particles 14 contain the corrosion-promoting component as a main component. As described above, the corrosion-promoting component is any of Fe, Ni, Co, Cu, and a compound containing at least one of the elements. Specific examples of the corrosion-promoting component include iron simple substance or iron-based compounds such as iron oxide, iron carbide, iron nitride, iron chloride, iron sulfide, iron carbonate, and iron hydroxide, nickel simple substance or nickel-based compounds such as nickel nickel carbide, nickel nitride, nickel chloride, nickel sulfide, nickel carbonate, nickel hydroxide, cobalt simple substance or cobalt-based compounds such as cobalt oxide, cobalt carbide, cobalt nitride, cobalt chloride, cobalt sulfide, cobalt carbonate, and cobalt hydroxide, and copper simple substance or copper-based compounds such as copper oxide, copper carbide, copper nitride, copper chloride, copper sulfide, copper carbonate, and copper hydroxide.

Among these, the corrosion-promoting component is preferably a copper-based compound. The copper-based compound is particularly preferably a copper oxide. The copper-based compound, in particular the copper oxide, contributes to particularly enhancing a corrosion rate of the matrix portion. Examples of the copper oxide include CuO and Cu₂O.

The corrosion-promoting component being a main component can be identified by having the highest element content of any of Fe, Ni, Co, and Cu in terms of atomic ratio as a result of elemental analysis. For the elemental analysis, for example, a qualitative and quantitative analysis based on an energy dispersive X-ray spectroscopy (EDX) is used. The element content of Fe, Ni, Co, or Cu in the metal-containing particles 14 may be higher than that of other elements, and is preferably more than 20 atomic %, and more preferably more than 40 atomic %.

An average particle diameter of the metal-containing particles 14 is 30 μm or less, preferably 0.2 μm or more and 15 μm or less, and more preferably 0.5 μm or more and 10 μm or less. By setting the average particle diameter of the metal-containing particles 14 within the above range, when the metal-containing particles 14 adhere to the surface of the metal body 11 and is subjected to the thixotropic molding, the metal-containing particles 14 can be uniformly distributed, and the metal-containing particles 14 are less likely to fall off from the surface of the metal body 11. As a result, a thixotropically molded product in which sites derived from the metal-containing particles 14 are satisfactorily dispersed can be produced.

When the average particle diameter of the metal-containing particles 14 is less than the above lower limit value, the particle diameter of the metal-containing particles 14 is too small, and thus the metal-containing particles 14 may be likely to aggregate in producing the thixotropic molding material 10. On the other hand, when the average particle diameter of the metal-containing particles 14 is more than the above upper limit value, the metal-containing particles 14 may be likely to fall off from the surface of the metal body 11.

The average particle diameter of the metal-containing particles 14 is a value obtained by measuring the particle diameters of the metal-containing particles 14 from an observation image of the metal-containing particles 14 magnified and observed with a microscope and averaging 100 or more pieces of measurement data. As the microscope, for example, a scanning electron microscope or an optical microscope is used. The particle diameters of the metal-containing particles 14 are intermediate values between a length of the major axis and a length of the minor axis in the observation image of the metal-containing particles 14.

A ratio of the metal-containing particles 14 to a total of the metal body 11 and the metal-containing particles 14 (an addition amount of the metal-containing particles 14) is 0.5 mass % or more and 30.0 mass % or less. By setting the ratio of the metal-containing particles 14 within the above range, the metal-containing particles 14 are less likely to fall off from the metal body 11. In addition, a ratio of the site derived from the metal body 11 to the site derived from the metal-containing particles 14 can be optimized in the produced thixotropically molded product. Accordingly, in the thixotropically molded product, a good balance can be achieved between the characteristics derived from Mg and the characteristics derived from the corrosion-promoting component. That is, it is possible to obtain a thixotropically molded product in which high specific strength and specific rigidity derived from Mg are further enhanced. The ratio of the metal-containing particles 14 is preferably 1.0 mass % or more and 20.0 mass % or less, and more preferably 1.5 mass % or more and 10.0 mass % or less.

When the ratio of the metal-containing particles 14 is less than the above lower limit value, the above-described local cell is not sufficiently formed, magnesium hydroxide is likely to be generated, and a rate of corrosion decreases. Therefore, hydrogen cannot be efficiently generated. On the other hand, when the ratio of the metal-containing particles 14 is more than the upper limit value, the metal-containing particles 14 are excessive, and thus the mechanical strength of the produced thixotropically molded product decreases, and handleability of the thixotropically molded product decreases.

The coating portion 12 may contain a substance other than the metal-containing particles 14. In this case, a content of the substance other than the metal-containing particles 14 may be less than the content of the metal-containing particles 14 in terms of mass ratio, and is preferably 30 mass % or less, and more preferably 10 mass % or less of the metal-containing particles 14.

The metal-containing particles 14 may be subjected to any surface treatment as necessary. Examples of the surface treatment include a plasma treatment, a corona treatment, an ozone treatment, an ultraviolet irradiation treatment, a roughening treatment, and a coupling agent treatment.

### 2.3. Bonding Portion

In the embodiment, the bonding portion 13 includes the interposed particles 15 in the form of particles. As shown in FIG. 3, the interposed particles 15 penetrate between the metal body 11 and the metal-containing particles 14 and between the metal-containing particles 14, and act to bond them.

The interposed particles 15 have an average particle diameter smaller than that of the metal-containing particles 14. Since such interposed particles 15 are minute, the interposed particles 15 easily enter between the metal body 11 and the metal-containing particles 14 or between the metal-containing particles 14. It is considered that the interposed particles 15 strongly interact with both the metal body 11 and the metal-containing particles 14 since the interposed particles 15 have a very large specific surface area. Examples of the interaction include an intermolecular force such as a hydrogen bond and a Van Der Waals force, and an anchor effect caused by an aggregate of the interposed particles 15 entering irregularities present on the surface of the metal body 11. In addition, hydroxy groups are often present in a high density on surfaces of the interposed particles 15 made of an inorganic material. The hydroxyl group forms a hydrogen bond with the metal body 11 and the metal-containing particles 14, which is considered to be a driving force for the interaction. Due to such interaction, the bonding portion 13 has a function of fixing the metal-containing particles 14 to the surface of the metal body 11.

Since the interposed particles 15 firmly fix the metal body 11 and the metal-containing particles 14, the metal-containing particles 14 are less likely to fall off. Therefore, when the thixotropic molding material 10 is charged into the heating cylinder 7 during the thixotropic molding, the semi-molten material of the metal body 11 and the metal-containing particles 14 are likely to be uniformly mixed. Accordingly, the metal-containing particles 14 and the interposed particles 15 can be uniformly dispersed in the thixotropically molded product.

The interposed particles 15 are particles made of an inorganic material. Examples of the inorganic material include oxides such as silicon oxide, aluminum oxide, and zirconium oxide, various nitrides, and various carbides. Among these, the oxide in particular has hydroxy groups in a high density on the surfaces of the interposed particles 15. The hydroxyl group forms a hydrogen bond with the metal body 11 and the metal-containing particles 14, which is considered to be a driving force for the interaction. Due to such interaction, the bonding portion 13 has a function of fixing the metal-containing particles 14 to the surface of the metal body 11.

The oxide is less likely to vaporize and is less likely to have a bad influence on the characteristics of the thixotropically molded product even when incorporated into the thixotropically molded product. Therefore, occurrence of molding defects due to vaporization is prevented, and a thixotropically molded product having excellent characteristics is obtained.

The oxide is particularly preferably a silicon oxide. The silicon oxide combines with magnesium to form a compound and functions as a reinforcing material that reinforces the mechanical properties of the thixotropically molded product. Therefore, by using the interposed particles 15 containing the silicon oxide, it is possible to obtain the thixotropic molding material 10 with which a thixotropically molded product having excellent mechanical properties while preventing the occurrence of molding defects due to the vaporization can be produced.

The silicon oxide acts to enhance wettability between the metal-containing particles 14 and the semi-molten material of the metal body 11 during the thixotropic molding. That is, since the interposed particles 15 are present adjacent to the metal-containing particles 14 in the thixotropic molding material 10, the interposed particles 15 are interposed between the metal-containing particles 14 and the metal body 11, thereby enhancing the affinity therebetween. Accordingly, in the produced thixotropically molded product, adhesion between the site derived from the metal-containing particles 14 and the site derived from the metal body 11 can be enhanced. As a result, in the thixotropically molded product, movement of electrons easily occurs between both sites, and thus corrosion accompanying the formation of the local cell can be further promoted.

In the present specification, the “silicon oxide” refers to a substance represented by a composition formula of SiOₓ (0<x≤2).

Containing the silicon oxide as a main component refers to that, when the elemental analysis is performed on the interposed particles 15, a content of one of Si and O is the highest and a content of the other is the second highest in terms of atomic ratio. For the elemental analysis, for example, a qualitative and quantitative analysis based on an energy dispersive X-ray spectroscopy (EDX) is used. A total content of Si and O in the interposed particles 15 may be higher than that of other elements, and is preferably more than 50 atomic %, more preferably 60 atomic % or more, and still more preferably 80 atomic % or more.

The interposed particles 15 may contain impurities in addition to the inorganic material described above. An allowable amount of the impurities is preferably 30 mass % or less, and more preferably 10 mass % or less of the interposed particles 15. Accordingly, inhibition of the effect due to the impurities is sufficiently reduced.

When the interposed particles 15 contain the silicon oxide, the silicon oxide may be crystalline, and is preferably amorphous. So-called amorphous silica is distributed under names of colloidal silica, fumed silica, or the like, and has a stable quality. Therefore, by using the interposed particles 15 containing the amorphous silica, it is possible to form the bonding portion 13 containing few coarse particles. As a result, the thixotropic molding material 10 that enables stable thixotropic molding is obtained.

As described above, it is sufficient that the average particle diameter of the interposed particles 15 is smaller than the average particle diameter of the metal-containing particles 14. Specifically, the average particle diameter of the interposed particles 15 is preferably 20% or less, more preferably 10% or less, and still more preferably 5% or less of the average particle diameter of the metal-containing particles 14. Accordingly, the interposed particles 15 are particularly likely to enter between the metal body 11 and the metal-containing particles 14 and between the metal-containing particles 14. The specific surface area of the interposed particles 15 is also particularly large.

The lower limit value may not necessarily be set, and is preferably 0.01% or more, more preferably 0.05% or more, and still more preferably 0.10% or more of the metal-containing particles 14 from the viewpoint of easy aggregation of the interposed particles 15 and difficulty in handling of the interposed particles 15.

The average particle diameter of the interposed particles 15 is preferably 1 nm or more and 100 nm or less, more preferably 10 nm or more and 80 nm or less, and still more preferably 20 nm or more and 60 nm or less. When the average particle diameter is within the above range, the interposed particles 15 are particularly likely to enter between the metal body 11 and the metal-containing particles 14 or between the metal-containing particles 14. The specific surface area of the interposed particles 15 is also particularly large. Further, when the average particle diameter is within the above range, aggregation of the interposed particles 15 is prevented.

The average particle diameter of the interposed particles 15 is a value obtained by measuring an intermediate value between a length of a major axis and a length of a minor axis of the interposed particles 15 as the particle diameter from an observation image of the interposed particles 15 magnified and observed with a microscope and averaging 100 or more pieces of measurement data. As the microscope, for example, a scanning electron microscope or an optical microscope is preferably used.

An addition amount of the interposed particles 15 is preferably 0.5 parts by mass or more and 12.0 parts by mass or less, more preferably 3.0 parts by mass or more and 11.0 parts by mass or less, and still more preferably 5.0 parts by mass or more and 10.0 parts by mass or less, when a total mass of the metal body 11 and the metal-containing particles 14 is 100 parts by mass. By setting the addition amount of the interposed particles 15 within the above range, it is possible to sufficiently secure a bonding function by the interposed particles 15 and to prevent generation of the excess interposed particles 15. When the addition amount of the interposed particles 15 is less than the above lower limit value, the interposed particles 15 are insufficient, and thus the metal-containing particles 14 may fall off from the metal body 11 depending on a surface state or the like of the metal body 11. On the other hand, when the addition amount of the interposed particles 15 is more than the above upper limit value, the interposed particles 15 are excessive, and thus an effect due to the addition of the metal-containing particles 14 may decrease, or aggregates of the interposed particles 15 may be generated.

The interposed particles 15 may be subjected to any surface treatment as necessary. Examples of the surface treatment include a plasma treatment, a corona treatment, an ozone treatment, an ultraviolet irradiation treatment, a roughening treatment, and a coupling agent treatment.

The bonding portion 13 may contain a substance other than the interposed particles 15. In this case, a content of the substance other than the interposed particles 15 may be less than the content of the interposed particles 15 in terms of mass ratio, and is preferably 10 mass % or less, and more preferably 5 mass % or less of the interposed particles 15.

Examples of the substance other than the interposed particles 15 include a resin. The resin increases a bonding force of the bonding portion 13. In addition, by using the interposed particles 15 and the resin in combination, it is possible to obtain the above-described effect while reducing an amount of the resin to be used.

Examples of the resin include various resins such as a polyolefin, an acrylic resin, a styrene-based resin, a polyester, a polyether, polyvinyl alcohol, polyvinyl pyrolidone, and a copolymer thereof, waxes, alcohols, higher fatty acids, fatty acid metals, higher fatty acid esters, higher fatty acid amides, nonionic surfactants, and silicone-based lubricants.

Examples of the polyolefin include a polyethylene, a polypropylene, and an ethylene-vinyl acetate copolymer. Examples of the acrylic resin include polymethyl methacrylate and polybutyl methacrylate. Examples of the styrene-based resin include a polystyrene. Examples of the polyester include polyvinyl chloride, polyvinylidene chloride, polyamide, polyethylene terephthalate, and polybutylene terephthalate.

The resin may be a mixture containing at least one of the above components and another component, or may be a mixture containing two or more of the above components.

Among these, the resin preferably contains waxes, and more preferably contains a paraffin wax or a derivative thereof. The wax has good binding capacity.

Examples of the waxes include natural waxes such as a plant wax, an animal wax and a mineral wax, synthetic waxes such as a synthetic hydrocarbon, a modified wax, a hydrogenated wax, a fatty acid, an acid amide, and an ester.

Examples of the plant wax include a candelilla wax, a carnauba wax, a rice wax, a Japan wax, and jojoba oil. Examples of the animal wax include a beeswax, lanolin, and spermaceti. Examples of the mineral wax include a montan wax, ozokerite, and ceresin.

Examples of the synthetic hydrocarbon include a polyethylene wax. Examples of the modified wax include montan wax derivatives, paraffin wax derivatives, and microcrystalline wax derivatives. Examples of the hydrogenated wax include hardened castor oil and hardened castor oil derivatives. Examples of the fatty acid include 12-hydroxystearic acid. Examples of the acid amide include stearic acid amides. Examples of the ester include phthalic anhydride ester.

When the bonding portion 13 contains a resin, the interposed particles 15 may be omitted. That is, the bonding portion 13 may be made of only resin. In this case, the bonding portion 13 also provides the above-described bonding action.

An addition amount of the resin is preferably 0.5 parts by mass or more and 12.0 parts by mass or less, and more preferably 3.0 parts by mass or more and 6.0 parts by mass or less, when a total mass of the metal body 11 and the metal-containing particles 14 is 100 parts by mass. By setting the addition amount of the resin within the above range, an excess amount of the resin can be reduced, and the function of the bonding portion 13 can be sufficiently secured while preventing the generation of a large amount of gas during the thixotropic molding.

### 2.4. Effects of First Embodiment

As described above, the thixotropic molding material 10 according to the first embodiment is a material used for producing a thixotropically molded product that generates hydrogen by contact with an aqueous solution, and includes the metal body 11, the metal-containing particles 14, and the bonding portion 13. The metal body 11 contains Mg as a main component. The metal-containing particles 14 adhere to the surface of the metal body 11 and contain, as a main component, any one of Fe, Ni, Co, Cu, and a compound containing at least one of the elements. The bonding portion 13 is interposed between the metal body 11 and the metal-containing particles 14. The average particle diameter of the metal-containing particles 14 is 30 μm or less. The ratio of the metal-containing particles 14 to the total of the metal body 11 and the metal-containing particles 14 is 0.5 mass % or more and 30.0 mass % or less.

According to such a thixotropic molding material 10, it is possible to produce a thixotropically molded product in which the above-described main component (corrosion-promoting component) is uniformly distributed in the matrix portion without impairing mechanical strength. In such a thixotropically molded product, the corrosion-promoting component is uniformly dispersed, and therefore, the local cell formed between the corrosion-promoting component and the matrix portion is distributed without bias. Therefore, there is less space and time for magnesium hydroxide that inhibits hydrogen generation to be produced, and as a result, corrosion progresses at a high rate. Therefore, the thixotropically molded product produced using the thixotropic molding material 10 according to the embodiment can efficiently generate hydrogen.

A compound containing in the corrosion-promoting component is preferably a copper oxide. In the thixotropically molded product obtained by subjecting the thixotropic molding material 10 to thixotropic molding, the copper oxide promotes corrosion of the matrix portion in particular. Therefore, when the thixotropically molded product is brought into contact with water, hydrogen can be particularly efficiently generated.

The bonding portion 13 is formed of the interposed particles 15 which are made of an inorganic material and have an average particle diameter smaller than that of the metal-containing particles 14, or a resin.

In such a thixotropic molding material 10, the bonding portion 13 penetrates between the metal body 11 and the metal-containing particles 14 and between the metal-containing particles 14, and acts to bond them. Accordingly, a thixotropically molded product in which the metal-containing particles 14 are satisfactorily dispersed can be produced.

The inorganic material is preferably a silicon oxide. The silicon oxide combines with magnesium to form a compound, and can enhance the mechanical properties of the thixotropically molded product. In addition, the silicon oxide acts to enhance wettability between the metal-containing particles 14 and the semi-molten material of the metal body 11 during the thixotropic molding. Accordingly, in the produced thixotropically molded product, adhesion between the site derived from the metal-containing particles 14 and the site derived from the metal body 11 can be enhanced. As a result, in the thixotropically molded product, a movement of electrons easily occurs between both sites, and thus corrosion accompanying the formation of the local cell can be further promoted.

### 3. Second Embodiment

Next, a method of producing a thixotropic molding material according to a second embodiment will be described. In the following description, a method of producing the above-described thixotropic molding material 10 will be described as an example.

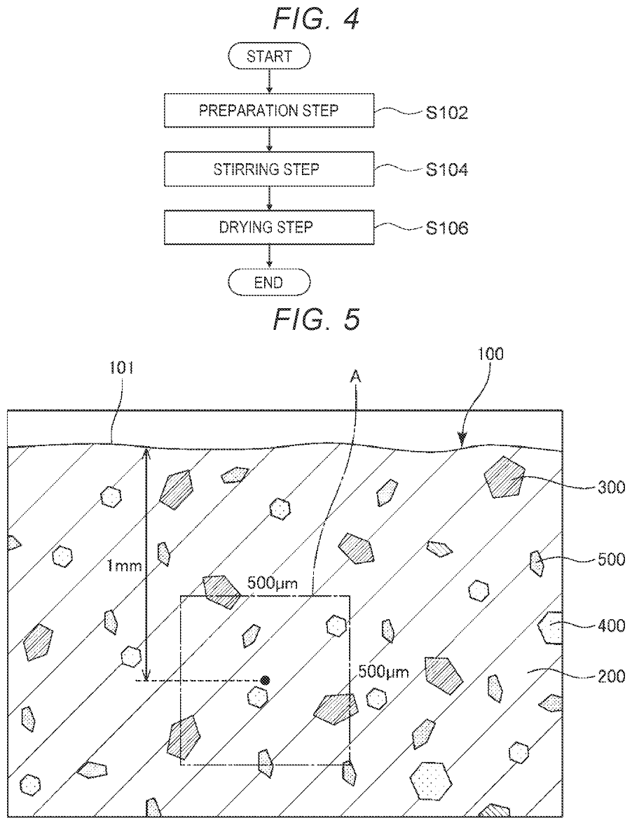

FIG. 4 is a step diagram showing the method of producing the thixotropic molding material 10 according to the second embodiment.

The method of producing the thixotropic molding material 10 shown in FIG. 4 includes a preparation step S102, a stirring step S104, and a drying step S106.

### 3.1. Preparation Step

In the preparation step S102, a mixture containing the metal body 11, the metal-containing particles 14, a binder, and a dispersion medium is prepared. The mixture is a dispersion liquid in which the metal body 11, the metal-containing particles 14, and the binder are dispersed using a sufficient amount of dispersion medium. Here, the binder contains the above-described interposed particles 15.

The dispersion medium is not particularly limited as long as the dispersion medium does not modify the metal body 11, the metal-containing particles 14, and the interposed particles 15. Examples of the dispersion medium include water, isopropyl alcohol, and acetone. In this step, a mixture produced in advance may be prepared. By containing water in the dispersion medium, it is possible to introduce hydroxy groups in a higher density to the surfaces s of the metal body 11, the metal-containing particles 14, and the interposed particles 15.

As described above, the average particle diameter of the metal-containing particles 14 contained in the thixotropic molding material 10 is 30 μm or less. Accordingly, in the stirring step S104 to be described later, adhesion of the metal-containing particles 14 to the metal body 11 can be enhanced. As a result, the thixotropic molding material 10 having a stable quality can be produced, and finally, a thixotropically molded product in which the metal-containing particles 14 are satisfactorily dispersed can be obtained.

As described above, the ratio of the metal-containing particles 14 to the total of the metal body 11 and the metal-containing particles 14 is 0.5 mass % or more and 30.0 mass % or less. By setting the ratio of the metal-containing particles 14 within the above range, the metal-containing particles 14 are less likely to fall off from the metal body 11. In addition, a ratio of the site derived from the metal body 11 to the site derived from the metal-containing particles 14 can be optimized in the produced thixotropically molded product.

### 3.2. Stirring Step

In the stirring step S104, the mixture is stirred. For stirring, for example, a method of using a stirring rod or a stirring bar, or a method of shaking a container containing a mixture in a state of being covered with a lid is used. By such stirring, the metal-containing particles 14 can adhere to the surface of the metal body 11 via the interposed particles 15. A part of the metal-containing particles 14 may directly adhere to the surface of the metal body 11 without the interposed particles 15 interposed therebetween. At this stage, the metal-containing particles 14 may adhere to the surface of the metal body 11 with a weak adhesive force. In addition, by stirring, aggregation of the metal body 11, aggregation of the metal-containing particles 14, and aggregation of the interposed particles 15 can be prevented.

### 3.3. Drying Step

In the drying step S106, the mixture is dried. Accordingly, the metal-containing particles 14 adhering to the surface of the metal body 11 via the interposed particles 15 adhere to the metal body 11 more firmly. For example, when hydroxy groups present on the surfaces of the interposed particles 15 and hydroxy groups present on the surfaces of the metal body 11 or the metal-containing particles 14 are bonded to each other by a weak adhesive force due to a hydrogen bond or the like, dehydration shrinkage occurs through this step, and the metal-containing particles 14 and the metal body 11 are bonded to each other by a stronger adhesive force. For example, silanol groups are present on the surfaces of the interposed particles 15. Through this step, the dehydration shrinkage occurs in the silanol groups, siloxane bonds are generated between the interposed particles 15, and the interposed particles 15 act like an adhesive. In this way, the metal-containing particles 14 are fixed to the metal body 11. When a resin is added to the mixture, the resin is melted by heating in the drying step S106 and solidified, and the metal-containing particles 14 are fixed.

In addition, the dispersion medium contained in the mixture can be sufficiently removed by drying. Accordingly, a vaporized component is sufficiently removed, and the thixotropic molding material 10 capable of preventing occurrence of molding defects due to vaporization during thixotropic molding is obtained. According to such a thixotropic molding material 10, it is possible to produce a dense thixotropically molded product with few pores.

For drying, a method of heating the mixture, a method of exposing the mixture to a gas, or the like is used. Among these, when in the case of heating the mixture, for example, the entire container containing the mixture may be heated using a hot bath or the like. In the drying step S106, all the dispersion medium in the mixture may be removed, or a part of the dispersion medium may remain without being removed.

As described above, the thixotropic molding material 10 is obtained. When the mixture contains a resin, a degreasing treatment may be performed on the thixotropic molding material 10 after the drying step S106.

### 3.4. Effects of Second Embodiment

As described above, the method of producing a thixotropic molding material according to the embodiment is a method of producing a material used for production of a thixotropically molded product that generates hydrogen by contact with an aqueous solution, and includes the preparation step S102, the stirring step $104, and the drying step S106. In the preparation step S102, a mixture containing the metal body 11 containing Mg as a main component, the metal-containing particles 14 containing, as a main component, any one of Fe, Ni, Co, Cu, and a compound containing at least one of the elements, a binder, and a dispersion medium is prepared. In the stirring step S104, the mixture is stirred. In the drying step S106, the metal-containing particles 14 adhere to the surface of the metal body 11 via the binder by removing at least a part of the dispersion medium from the stirred mixture. Further, the average particle diameter of the metal-containing particles 14 is 30 μm or less. In the mixture, the ratio of the metal-containing particles 14 to the total of the metal body 11 and the metal-containing particles 14 is 0.5 mass % or more and 30.0 mass % or less.

According to such a production method, since the metal body 11 and the metal-containing particles 14 are more firmly fixed to each other via the binder, it is possible to produce the thixotropic molding material 10 in which the metal-containing particles 14 are less likely to fall off. In such a thixotropic molding material 10, the metal-containing particles 14 and the binder can be uniformly dispersed during the thixotropic molding. As a result, it is possible to produce a thixotropically molded product in which the above-described main component (corrosion-promoting component) is uniformly distributed in the matrix portion without impairing the mechanical strength. In such a thixotropically molded product, the corrosion-promoting component is uniformly dispersed, and therefore, the local cell formed between the corrosion-promoting component and the matrix portion is distributed without bias. Therefore, there is less space and time for magnesium hydroxide that inhibits hydrogen generation to be produced, and as a result, corrosion progresses at a high rate. Therefore, the thixotropically molded product produced using the thixotropic molding material 10 according to the embodiment can efficiently generate hydrogen.

### 4. Third Embodiment

Next, a thixotropically molded product according to a third embodiment will be described. In the following description, a thixotropically molded product produced using the interposed particles 15 containing a silicon oxide will be described as an example.

FIG. 5 is a partial cross-sectional view schematically showing a thixotropically molded product 100 according to the third embodiment.

The thixotropically molded product 100 shown in FIG. 5 has a matrix portion 200, and first particle portions 300, second particle portions 400, and third particle portions 500 dispersed in the matrix portion 200. Shapes and distribution states of the first particle portions 300, the second particle portions 400, and the third particle portions 500 shown in FIG. 5 are schematic. When the thixotropic molding material 10 does not contain the interposed particles 15, the thixotropically molded product 100 does not include the second particle portions 400 and the third particle portions 500.

The matrix portion 200 contains Mg as a main component. The first particle portions 300 contain the corrosion-promoting component as a main component. The second particle portions 400 contain Mg₂Si as a main component. The third particle portions 500 contain MgO as a main component. The second particle portions 400 and the third particle portions 500 are sites derived from the interposed particles 15. Further, an area fraction of the first particle portions 300 in a cross section of the thixotropically molded product 100 is 0.5% or more and 20.0% or less.

In such a thixotropically molded product 100, refinement of the Mg crystals can be achieved with the first particle portions 300. Accordingly, high specific strength and specific rigidity derived from the matrix portion 200 can be further enhanced.

In addition, the second particle portions 400 and the third particle portions 500 also contribute to the refinement of the Mg crystals. At least a part of Mg₂Si or MgO is distributed to be adjacent to the first particle portions 300. Accordingly, wettability between the first particle portions 300 and the matrix portion 200 can be enhanced. As a result, the thixotropically molded product 100 is dense and is particularly excellent in mechanical properties and hydrogen generation efficiency.

Further, since the thixotropically molded product 100 is formed by the thixotropic molding method, any three-dimensional shape can be easily provided. Therefore, it is possible to easily implement the thixotropically molded product 100 having a shape having a large surface area such as a fin shape. The thixotropically molded product 100 having such a shape exhibits particularly high hydrogen generation efficiency.

The thixotropically molded product 100 has not only high hydrogen generation efficiency but also high mechanical strength because the first particle portions 300, the second particle portions 400, and the third particle portions 500 function as reinforcing materials. Therefore, for example, even when the thixotropically molded product 100 is formed into a shape having a large surface area such as a fin shape, it is possible to prevent occurrence of chipping, cracking, or the like, and it is easy to pursue a shape having a larger surface area. Therefore, in the thixotropically molded product 100, high hydrogen generation efficiency can be stably secured.

### 4.1. Matrix Portion

The matrix portion 200 contains Mg as a main component. Containing Mg as a main component refers to that, when elemental analysis is performed on a cross section of the matrix portion 200, a content of Mg is the highest in terms of atomic ratio. For the elemental analysis, for example, a qualitative and quantitative analysis based on an energy dispersive X-ray spectroscopy (EDX) is used. The content of Mg in the matrix portion 200 may be higher than that of other elements, and is preferably more than 50 atomic %, more preferably 70 atomic % or more, and still more preferably 80 atomic % or more. During identification of the matrix portion 200 in the qualitative and quantitative analysis, the matrix portion 200 can be distinguished based on a contrast with other sites or a color tone in, for example, an observation image from a scanning electron microscope or an optical microscope. The matrix portion 200 may contain additives or impurities other than Mg.

The matrix portion 200 occupies the highest area fraction in the cross section of the thixotropically molded product 100. Therefore, the matrix portion 200 has a dominant influence on the mechanical properties of the thixotropically molded product 100. Accordingly, high specific rigidity and high specific strength of Mg are reflected in the thixotropically molded product 100.

The matrix portion 200 is a site derived from the metal body 11, for example, when the matrix portion 200 is produced using the above-described thixotropic molding material 10. In this case, the matrix portion 200 is a site having a composition substantially the same as that of the metal body 11.

An average particle diameter of the Mg crystals in the thixotropically molded product 100 is preferably 1.0 μm or more and 8.0 μm or less, more preferably 2.0 μm or more and 7.0 μm or less, and still more preferably 3.0 μm or more and 6.0 μm or less.

When the average particle diameter of the Mg crystals is within the above range, a movement of dislocation is particularly less likely to occur at a grain boundary of the Mg crystals. Therefore, the mechanical strength and the rigidity of the thixotropically molded product 100 can be particularly enhanced.

The Mg crystals can be identified on an image by performing crystal orientation analysis (EBSD analysis) on a cut surface of the matrix portion 200. Accordingly, an intermediate value between a length of a major axis and a length of a minor axis of the Mg crystals identified on the image can be set as a particle diameter of the Mg crystals. The average particle diameter of the Mg crystals can be obtained by averaging 100 or more measured particle diameters.

### 4.2. First Particle Portion (Corrosion-Promoting Component)

The first particle portions 300 contain, as a main component, a corrosion-promoting component, that is, any one of Fe, Ni, Co, Cu, and a compound containing at least one of the elements. The corrosion-promoting component being the main component can be identified by the highest element content of any of Fe, Ni, Co, and Cu in terms of atomic ratio as a result of elemental analysis. For the elemental analysis, for example, a qualitative and quantitative analysis based on an energy dispersive X-ray spectroscopy (EDX) is used. The element content of Fe, Ni, Co, or Cu in the first particle portions 300 may be higher than that of other elements, and is preferably more than 20 atomic %, and more preferably more than 40 atomic %. During the identification of the first particle portions 300 in the qualitative and quantitative analysis, the first particle portions 300 can be distinguished based on a contrast with other sites or a color tone in, for example, an observation image from a scanning electron microscope or an optical microscope. The first particle portions 300 may contain additives or impurities other than the corrosion-promoting component.

Among these, the first particle portions 300 preferably contain a Cu simple substance or a Cu-based compound as a main component. The Cu-based compound is particularly preferably a copper oxide, a Cu—Al compound, or a Cu—Al—Mg compound. Accordingly, the hydrogen generation efficiency of the thixotropically molded product 100 can be particularly enhanced. Even when a magnesium hydroxide layer is formed in the matrix portion 200, efficiency of breaking the layer is considered to be high, and therefore, the thixotropically molded product 100 that can generate hydrogen for a longer period of time can be implemented.

Examples of the copper oxide include CuO and Cu₂O. The Cu—Al compound is a compound in which a content of Cu is the highest and a content of Al is the second highest in terms of atomic ratio. Further, the Cu—Al—Mg compound is a compound in which contents of Cu, Al, and Mg are from the highest to the lowest in this order in terms of atomic ratio.

In the observation image of the cross section of the thixotropically molded product 100 shown in FIG. 5, a range A of 500 μm square is set around a point at a depth of 1 mm from a surface 101. A proportion of an area of the first particle portions 300 to an area of the range A is defined as an area fraction of the first particle portions 300. Since the range A is a region set to a sufficient depth, it can be considered that the range A represents an average structure of the thixotropically molded product 100.

The area fraction described above is 0.5% or more and 20.0% or less. By setting the area fraction within the above range, the above-described effect by the first particle portions 300, specifically, the thixotropically molded product 100 in which the above-described main component (corrosion-promoting component) is uniformly distributed in the matrix portion 200 can be obtained without impairing the mechanical strength. In such a thixotropically molded product 100, the corrosion-promoting component is uniformly dispersed, and therefore, the local cell formed between the corrosion-promoting component and the matrix portion 200 is distributed without bias. Therefore, there is less space and time for magnesium hydroxide that inhibits hydrogen generation to be produced, and as a result, corrosion progresses at a high rate. Therefore, according to the thixotropically molded product 100, hydrogen can be efficiently generated.

When the area fraction is less than the above lower limit value, the first particle portions 300 are insufficient, and thus the above-described effect cannot be obtained. On the other hand, when the area fraction is more than the above upper limit value, the first particle portions 300 are excessive, and the mechanical strength of the thixotropically molded product 100 decreases. Since the ratio of the matrix portion 200 is relatively decreased, the hydrogen generation efficiency decreases. The area fraction is preferably 1.0% or more and 15.0% or less, and more preferably 2.0% or more and 10.0% or less.

The area fraction in the range A is calculated as follows. First, a range of the first particle portions 300 is extracted by image processing in the range A. For the image processing, for example, image analysis software OLYMPUS Stream or the like can be used. A magnification of the observation image is preferably 300 times or more. Next, a proportion of the area of the first particle portion 300 to the entire area of the range A is calculated. The proportion is defined as the area fraction.

An average particle diameter of the first particle portions 300 is 30.0 μm or less, preferably 0.2 μm or more and 15.0 μm or less, and more preferably 0.5 μm or more and 10.0 μm or less. Accordingly, the first particle portions 300 are less likely to become a starting point of breakage, and thus the mechanical strength of the thixotropically molded product 100 can be enhanced without impairing the rigidity of the matrix portion 200.

The average particle diameter of the first particle portions 300 is calculated as follows. First, a length of a major axis and a length of a minor axis of each of the first particle portions 300 included in the range A are determined. Next, an intermediate value between the length of the major axis and the length of the minor axis is determined. An average value of the intermediate values calculated in this manner is the average particle diameter of the first particle portions 300.

An average aspect ratio of the first particle portions 300 is preferably 4.0 or less, more preferably 3.0 or less, and still more preferably 2.0 or less. When the average aspect ratio of the first particle portions 300 is within the above range, anisotropy of structures of the first particle portions 300 is reduced. Therefore, the mechanical strength and the rigidity of the thixotropically molded product 100 can be isotropically enhanced.

The average aspect ratio of the first particle portions 300 is calculated as follows. First, a length of a major axis and a length of a minor axis of each of the first particle portions 300 included in the range A are determined. Next, a ratio of the length of the major axis to the length of the minor axis is referred to as an “aspect ratio”. An average value of the aspect ratios calculated in this manner is the average aspect ratio of the first particle portions 300.

### 4.3. Second Particle Portion (Mg₂Si)

The second particle portions 400 contain Mg₂Si as a main component, and have a particulate shape. The second particle portions 400 also contribute to enhancing the wettability between the first particle portions 300 and the matrix portion 200. Accordingly, voids and the like are less likely to be generated between the first particle portions 300 and the matrix portion 200, and the thixotropically molded product 100 can be made denser. As a result, corrosion accompanying the formation of the local cell can be further promoted.

Containing Mg₂Si as a main component refers to that, when elemental analysis is performed on cross sections of the second particle portions 400, a content of Mg is the highest and a content of Si is the second highest in terms of atomic ratio. For the elemental analysis, for example, a qualitative and quantitative analysis based on an energy dispersive X-ray spectroscopy (EDX) is used. A total content of Mg and Si in the second particle portions 400 may be higher than other elements, and is preferably more than 50 atomic %, and more preferably 60 atomic % or more. During the identification of the second particle portions 400 in the qualitative and quantitative analysis, the second particle portions 400 can be distinguished based on a contrast with the matrix portion 200 and other sites or a color tone in, for example, an observation image from a scanning electron microscope or an optical microscope. The second particle portions 400 may contain additives or impurities other than Mg₂Si.

The second particle portions 400 also have a function of preventing coarsening of the Mg crystals contained in the matrix portion 200. Therefore, in the thixotropically molded product 100, refinement of the Mg crystals in the matrix portion 200 is achieved. Accordingly, the thixotropically molded product 100 has high mechanical strength.

An average particle diameter of the second particle portions 400 is preferably 10.0 μm or less, more preferably 0.1 μm or more and 8.0 μm or less, and still more preferably 0.3 μm or more and 5.0 μm or less. Accordingly, the second particle portions 400 can effectively contribute to the refinement of the Mg crystals and can be prevented from becoming a starting point of breakage. When the average particle diameter of the second particle portions 400 is less than the above lower limit value, the effect of the second particle portions 400 may be reduced. On the other hand, when the average particle diameter of the second particle portions 400 is more than the above upper limit value, the refinement of the Mg crystals may be insufficient, and the second particle portions 400 may inhibit the formation of the local cell.

The average particle diameter of the second particle portions 400 is calculated as follows. First, a length of a major axis and a length of a minor axis of each of the second particle portions 400 included in the range A are determined. Next, an intermediate value between the length of the major axis and the length of the minor axis is determined. An average value of the intermediate values calculated in this manner is the average particle diameter of the second particle portions 400.

### 4.4. Third Particle Portion (MgO)

The third particle portions 500 contain MgO as a main component, and have a particulate shape. The third particle portions 500 also contribute to enhancing the wettability between the first particle portions 300 and the matrix portion 200. Therefore, at least a part of the third particle portions 500 are preferably adjacent to the first particle portions 300. Accordingly, voids and the like are less likely to be generated between the first particle portions 300 and the matrix portion 200, and the thixotropically molded product 100 can be made denser. As a result, corrosion accompanying the formation of the local cell can be further promoted.

Containing MgO as a main component refers to that, when elemental analysis is performed on cross sections of the third particle portions 500, a content of one of Mg and O is the highest and a content of the other is the second highest in terms of atomic ratio. For the elemental analysis, for example, a qualitative and quantitative analysis based on an energy dispersive X-ray spectroscopy (EDX) is used. A total content of Mg and O in the third particle portions 500 may be higher than other elements, and is preferably more than 50 atomic %, and more preferably 60 atomic % or more. During the identification of the third particle portions 500 in the qualitative and quantitative analysis, the third particle portions 500 can be distinguished based on a contrast with the matrix portion 200 and other sites or a color tone in, for example, an observation image from a scanning electron microscope or an optical microscope. The third particle portions 500 may contain additives or impurities other than MgO.

In addition, the third particle portions 500 have a function of preventing coarsening of the Mg crystals contained in the matrix portion 200. Therefore, in the thixotropically molded product 100, refinement of the Mg crystals in the matrix portion 200 is achieved. Accordingly, the thixotropically molded product 100 has high mechanical strength.

An average particle diameter of the third particle portions 500 is preferably smaller than the average particle diameter of the second particle portions 400, and is more preferably 18 or more and 60% or less, still more preferably 2% or more and 50% or less, and particularly preferably 3% or more and 40% or less of the average particle diameter of the second particle portions 400. Accordingly, the third particle portion 500 exerts the above-described function without becoming a starting point of breakage or inhibiting the function of the first particle portions 300 or the second particle portions 400.

The average particle diameter of the third particle portions 500 is calculated as follows. First, a length of a major axis and a length of a minor axis of each of the third particle portions 500 included in the range A are determined. Next, an intermediate value between the length of the major axis and the length of the minor axis is determined. An average value of the intermediate values calculated in this manner is the average particle diameter of the third particle portions 500.

A total area of the second particle portions 400 and the third particle portions 500 in the cross section of the thixotropically molded product 100 is preferably 1.0 or more and 30.0 or less, more preferably 2.0 or more and 25.0 or less, and still more preferably 3.0 or more and 20.0 or less, when the area of the first particle portions 300 is 100. Accordingly, the above-described effects of the second particle portions 400 and the third particle portions 500 can be obtained without impairing the effect of the first particle portions 300. That is, it is possible to improve a balance of an existence ratio of the first particle portions 300, the second particle portions 400, and the third particle portions 500. As a result, the mechanical properties and the hydrogen generation efficiency of the thixotropically molded product 100 can be particularly enhanced.

### 4.5. Effects of Third Embodiment

As described above, the thixotropically molded product 100 according to the third embodiment generates hydrogen by contact with the aqueous solution, and includes the matrix portion 200 and the first particle portions 300 dispersed in the matrix portion 200. The matrix portion 200 contains Mg as a main component. The first particle portions 300 contain the corrosion-promoting component as a main component. The corrosion-promoting component is any of Fe, Ni, Co, Cu, and a compound containing at least one of the elements. Further, the average particle diameter of the first particle portions 300 in the cross section of the thixotropically molded product 100 is 30.0 μm or less. The area fraction of the first particle portions 300 in the cross section is 0.5% or more and 20.0% or less.

According to such a configuration, in the thixotropically molded product 100, the first particle portions 300 can function as a reinforcing material, and a local cell can be formed between the first particle portions 300 and the matrix portion 200. Since the first particle portions 300 are uniformly distributed in the matrix portion 200, the local cell can also be uniformly distributed without bias. Therefore, there is less space and time for magnesium hydroxide that inhibits hydrogen generation to be produced, and as a result, corrosion progresses at a high rate. Therefore, with the thixotropically molded product 100 according to the embodiment, hydrogen can be efficiently generated.

The thixotropically molded product 100 according to the third embodiment includes the second particle portions 400 and the third particle portions 500. The second particle portions 400 are dispersed in the matrix portion 200 and contain Mg₂Si as a main component. The third particle portions 500 are dispersed in the matrix portion 200 and contain MgO as a main component.

The second particle portions 400 and the third particle portions 500 contribute to the refinement of the Mg crystals. At least a part of Mg₂Si or MgO is distributed to be adjacent to the first particle portions 300. Accordingly, the wettability between the first particle portions 300 and the matrix portion 200 can be enhanced. As a result, the thixotropically molded product 100 becomes dense, and a movement of electrons easily occurs between the first particle portions 300 and the matrix portions 200, and thus corrosion accompanying the formation of the local cell can be further promoted.

In the thixotropically molded product 100 according to the third embodiment, the average particle diameter of the second particle portions 400 is preferably 10.0 μm or less. Further, the average particle diameter of the third particle portions 500 is preferably smaller than the average particle diameter of the second particle portions 400.

Accordingly, it is possible to prevent the second particle portions 400 from becoming a starting point of breakage, and the second particle portions 400 are less likely to inhibit the formation of the local cell by the first particle portions 300. In addition, it is possible to prevent the third particle portions 500 from becoming a starting point of breakage, and the third particle portions 500 are less likely to inhibit the functions of the first particle portions 300 and the second particle portions 400.

The thixotropically molded product, the thixotropic molding material, and the method of producing the thixotropic molding material according to the present disclosure are described above based on the shown embodiments, and the present disclosure is not limited to the above-described embodiments. For example, the thixotropic molding material and the thixotropically molded product according to the present disclosure may be those obtained by adding any components to the above-described embodiments. The method of producing the thixotropic molding material according to the present disclosure may be a method in which any step is added to the above-described embodiments.

### Examples

Next, specific Examples of the present disclosure will be described.

### 5. Production of Thixotropic Molding Material

### 5.1. Sample No. 1

First, a magnesium alloy chip as a metal body, a Cuo powder as metal-containing particles, a silica (silicon oxide) powder as interposed particles, and IPA (isopropyl alcohol) as a dispersion medium were mixed to obtain a mixture. A chip of 4 mm×2 mm×1 mm made of an AZ91D alloy manufactured by Nippon Material Co., Ltd. was used as the magnesium alloy chip. The AZ91D alloy is an Mg-based alloy containing 9 mass % of Al and 1 mass % of Zn. Colloidal silica (amorphous silica) obtained by colloidal dispersion in IPA was used as the silica powder. Production conditions for other thixotropic molding materials are as shown in Table 1.

Next, the mixture was stirred. A method of shaking a container containing the mixture was used for stirring.

Next, the stirred mixture was heated and dried. Accordingly, a thixotropic molding material was obtained.

### 5.2. Sample Nos. 2 to 9

A thixotropic molding material was obtained in the same manner as in the case of Sample No. 1 except that the production conditions for the thixotropic molding material were changed as shown in Table 1. In Sample No. 8, a paraffin wax as resin was used as a binder instead of the silica powder.

### 5.3. Sample No. 10

A thixotropic molding material was obtained in the same manner as in the case of Sample No. 1 except that addition of the CuO powder and addition of the silica powder were omitted, that is, only the magnesium alloy chip was subjected to the thixotropic molding.

### 5.4. Sample No. 11

A thixotropic molding material was obtained in the same manner as in the case of Sample No. 1 except that the addition of the CuO powder was omitted, that is, only the magnesium alloy chip and the silica powder were subjected to the thixotropic molding.

### 5.5. Sample Nos. 12 to 21

A thixotropic molding material was obtained in the same manner as in the case of Sample No. 1 except that the production conditions for the thixotropic molding material were changed as shown in Table 2.

### 5.6. Sample No. 22

A thixotropic molding material was obtained in the same manner as in the case of Sample No. 1, except that a Fe₂O₃ powder was used instead of the CuO powder, and the production conditions for the thixotropic molding material were changed as shown in Table 2.

### 5.7. Sample No. 23

A thixotropic molding material was obtained in the same manner as in the case of Sample No. 1, except that a NiO powder was used instead of the CuO powder, and the production conditions for the thixotropic molding material were changed as shown in Table 2.

### 5.8. Sample No. 24

A thixotropic molding material was obtained in the same manner as in the case of Sample No. 1, except that a Co₃O₄ powder was used instead of the CuO powder, and the production conditions for the thixotropic molding material were changed as shown in Table 2.

### 5.9. Sample No. 25

A thixotropic molding material was obtained in the same manner as in the case of Sample No. 1, except that an alumina (aluminum oxide) powder was used instead of the silica powder, and the production conditions for the thixotropic molding material were changed as shown in Table 2.

TABLE 1

| | | Production condition for thixotropic molding material | | | | | | | Evaluation result |
|---|---|---|---|---|---|---|---|---|---|
| | | | | | Binder | | | | of thixotropic |
| | | Metal-containing particles | | | Constituent | | | | molding material |
| | | | Average | | material of | Average | Particle | | Adhesion of |
| | Example/ | Constituent | particle | Addition | interposed | particle | diameter | Addition | metal-containing |
| Sample | Comparative | material | diameter | amount | particles | diameter | ratio | amount | particles |
| No. | Example | — | μm | mass % | — | nm | % | Parts by mass | — |
| 1 | Comparative | CuO | 5 | 0.3 | Silicon oxide | 45 | 0.90 | 5.0 | A |
| | Example | | | | | | | | |
| 2 | Example | CuO | 5 | 0.7 | Silicon oxide | 45 | 0.90 | 5.0 | A |
| 3 | Example | CuO | 5 | 1.2 | Silicon oxide | 45 | 0.90 | 5.0 | A |
| 4 | Example | CuO | 5 | 3.0 | Silicon oxide | 45 | 0.90 | 5.0 | A |
| 5 | Example | CuO | 5 | 9.0 | Silicon oxide | 45 | 0.90 | 5.0 | A |
| 6 | Example | CuO | 5 | 15.0 | Silicon oxide | 45 | 0.90 | 5.0 | B |
| 7 | Example | CuO | 5 | 25.0 | Silicon oxide | 45 | 0.90 | 5.0 | B |
| 8 | Example | CuO | 5 | 10.0 | Paraffin wax | | | | A |
| | | | | | 5.0 parts by mass | | | | |
| 9 | Comparative | CuO | 5 | 35.0 | Silicon oxide | 45 | 0.90 | 5.0 | D |
| | Example | | | | | | | | |
| 10 | Comparative | — | — | 0.0 | — | — | — | — | — |
| | Example | | | | | | | | |
| 11 | Comparative | — | — | 0.0 | Silicon oxide | 45 | — | 5.0 | — |
| | Example | | | | | | | | |

TABLE 2

| | | Production condition for thixotropic molding material | | | | | | | Evaluation result |
|---|---|---|---|---|---|---|---|---|---|
| | | | | | Binder | | | | of thixotropic |
| | | Metal-containing particles | | | Constituent | | | | molding material |
| | | | Average | | material of | Average | Particle | | Adhesion of |
| | Example/ | Constituent | particle | Addition | interposed | particle | diameter | Addition | metal-containing |
| Sample | Comparative | material | diameter | amount | particles | diameter | ratio | amount | particles |
| No. | Example | — | μm | mass % | — | nm | % | Parts by mass | — |
| 12 | Example | CuO | 0.3 | 5.0 | Silicon oxide | 5 | 1.67 | 5.0 | A |
| 13 | Example | CuO | 1 | 5.0 | Silicon oxide | 45 | 4.50 | 5.0 | A |
| 14 | Example | CuO | 8 | 5.0 | Silicon oxide | 45 | 0.56 | 5.0 | A |
| 15 | Example | CuO | 10 | 5.0 | Silicon oxide | 20 | 0.20 | 5.0 | A |
| 16 | Example | CuO | 25 | 5.0 | Silicon oxide | 20 | 0.08 | 5.0 | C |
| 17 | Example | CuO | 5 | 10.0 | Silicon oxide | 100 | 2.00 | 5.0 | B |
| 18 | Example | CuO | 5 | 5.0 | Silicon oxide | 45 | 0.90 | 0.5 | C |
| 19 | Example | CuO | 5 | 5.0 | Silicon oxide | 45 | 0.90 | 3.0 | A |
| 20 | Example | CuO | 5 | 5.0 | Silicon oxide | 45 | 0.90 | 7.0 | A |
| 21 | Example | CuO | 5 | 5.0 | Silicon oxide | 45 | 0.90 | 10.0 | A |
| 22 | Example | Fe₂O₃ | 5 | 5.0 | Silicon oxide | 45 | 0.90 | 5.0 | A |
| 23 | Example | NiO | 5 | 5.0 | Silicon oxide | 45 | 0.90 | 5.0 | A |
| 24 | Example | Co₃O₄ | 5 | 5.0 | Silicon oxide | 45 | 0.90 | 5.0 | A |
| 25 | Example | CuO | 5 | 5.0 | Aluminum oxide | 50 | 1.00 | 5.0 | B |

In Tables 1 and 2, among the thixotropic molding materials of respective sample Nos., those corresponding to the present disclosure are indicated by “Examples”, and those not corresponding to the present disclosure are indicated by “Comparative Examples”.

### 6. Evaluation of Thixotropic Molding Material

Vibration was applied to the thixotropic molding material of each sample No. Next, a weight was measured before and after the vibration was applied, and a weight loss amount was calculated. Then, based on the calculated weight loss amount in light of the following evaluation criteria, adhesion of the metal-containing particles and the particles instead of the metal-containing particles in the thixotropic molding material was evaluated.
A: the adhesion of the metal-containing particles and the like is particularly good (the weight loss amount due to vibration is very small).
B: the adhesion of the metal-containing particles and the like is slightly good (the weight loss amount due to vibration is slightly small).
C: the adhesion of the metal-containing particles and the like is slightly poor (the weight loss amount due to vibration is slightly large).
D: the adhesion of the metal-containing particles and the like is particularly poor (the weight loss amount due to vibration is very large).

Evaluation results are shown in Tables 1 and 2.

In each Example shown in Table 1, it is found that the adhesion of the metal-containing particles can be sufficiently enhanced by setting the addition amount of the metal-containing particles within a predetermined range. In each Example shown in Table 2, it is found that the adhesion of the metal-containing particles can be sufficiently enhanced by setting the average particle diameter of the metal-containing particles within a predetermined range. Further, in each Example shown in Table 2, it is found that the adhesion of the metal-containing particles can be sufficiently enhanced by setting the addition amount of the binder within a predetermined range.

### 7. Analysis of Configuration of Thixotropically Molded Product

The thixotropic molding material of each sample No. was charged into an injection molding machine and subjected to thixotropic molding to obtain a thixotropically molded product. As the injection molding machine, a magnesium injection molding machine JLM75MG manufactured by The JAPAN STEEL WORKS, LTD. was used.

Next, the thixotropically molded product of each sample No. was cut, and a cut surface was observed with an optical microscope. Further, based on an observation image, the matrix portion, the first particle portions, the second particle portions, and the third particle portions were identified, and an average particle diameter and a particle diameter ratio were calculated.

Next, an area fraction of the first particle portions was calculated. A ratio of the total area of the second particle portions and the third particle portions to the area of the first particle portions was calculated. The above calculation results are shown in Tables 3 and 4.

### 8. Evaluation Results of Thixotropically Molded Product

For the thixotropically molded product of each sample No., a weight change rate accompanying immersion in salt water was evaluated by the following procedure.

First, a test piece having a size of 10 mm×10 mm×2.5 mm was cut out from the thixotropically molded product. Then, a surface of the test piece was polished with #800 waterproof abrasive paper.

Next, the surface-polished test piece was immersed in a sodium chloride aqueous solution having a concentration of 3.5 mass %. Then, the weight was measured 5 hours, 30 hours, and 5 days after the start of immersion.

Next, by dividing a weight of the test piece after immersion for a predetermined period of time by a weight of the test piece before the start of immersion, the weight change rate at each time was calculated. Then, hydrogen generation efficiency was evaluated based on the calculated weight change rate in light of the following evaluation criteria.
A: the hydrogen generation efficiency is particularly high (the weight change rate is 30% or more).
B: the hydrogen generation efficiency is high (the weight change rate is 20% or more and less than 30%).
C: the hydrogen generation efficiency is slightly high (the weight change rate is 10% or more and less than 20%).
D: the hydrogen generation efficiency is slightly low (the weight change rate is 5% or more and less than 10%).
E: the hydrogen generation efficiency is low (the weight change rate is 2% or more and less than 5%).
F: the hydrogen generation efficiency is particularly low (the weight change rate is less than 2%).

Evaluation results are shown in Tables 3 and 4.

TABLE 3

| | | Configuration of thixotropically molded product | | | | | | | |
|---|---|---|---|---|---|---|---|---|---|
| | | Area | | | | | | | |
| | | | Ratio of | | | | Evaluation result | | |
| | | | total area | Average particle diameter | | | of thixotropic | | |
| | | | of second | | | Particle | molding material | | |
| | | Area | particle portion | | | diameter | Relationship between immersion | | |
| | | fraction | and third | | | ratio of third | time in salt water and | | |
| | | of first | particle portion | First | Second | particle portion | weight change rate | | |
| | Example/ | particle | to area of first | particle | particle | to second | After | After | After |
| Sample | Comparative | portion | particle portion | portion | portion | particle portion | 5 hours | 30 hours | 5 days |
| No. | Example | % | % | μm | μm | % | — | — | — |
| 1 | Comparative | 0.2 | 45.0 | 3.2 | 3.6 | 60 | F | E | C |
| | Example | | | | | | | | |
| 2 | Example | 0.5 | 28.0 | 4.2 | 4.5 | 40 | D | C | B |
| 3 | Example | 0.8 | 24.3 | 3.5 | 5.4 | 20 | C | B | A |
| 4 | Example | 2.2 | 15.6 | 2.9 | 5.3 | 26 | B | A | A |
| 5 | Example | 7.4 | 10.3 | 3.5 | 3.4 | 12 | B | A | A |
| 6 | Example | 9.3 | 2.4 | 4.6 | 2.9 | 55 | B | B | A |
| 7 | Example | 19.3 | 1.9 | 5.8 | 3.6 | 18 | C | B | A |
| 8 | Example | 12.3 | — | 5.1 | — | — | D | C | B |
| 9 | Comparative | 28.5 | 3.9 | 6.5 | 4.5 | 15 | E | D | C |
| | Example | | | | | | | | |
| 10 | Comparative | — | — | — | — | — | F | F | F |
| | Example | | | | | | | | |
| 11 | Comparative | — | — | — | 208 | 56 | F | F | F |
| | Example | | | | | | | | |

TABLE 4

| | | Configuration of thixotropically molded product | | | | | | | |
|---|---|---|---|---|---|---|---|---|---|
| | | Area | | | | | | | |
| | | | Ratio of | | | | Evaluation result | | |
| | | | total area | Average particle diameter | | | of thixotropic | | |
| | | | of second | | | Particle | molding material | | |
| | | Area | particle portion | | | diameter | Relationship between immersion | | |
| | | fraction | and third | | | ratio of third | time in salt water and | | |
| | | of first | particle portion | First | Second | particle portion | weight change rate | | |
| | Example/ | particle | to area of first | particle | particle | to second | After | After | After |
| Sample | Comparative | portion | particle portion | portion | portion | particle portion | 5 hours | 30 hours | 5 days |
| No. | Example | % | % | μm | μm | % | — | — | — |
| 12 | Example | 4.3 | 10.3 | 0.3 | 2.5 | 45 | B | A | A |
| 13 | Example | 3.4 | 8.6 | 0.9 | 1.8 | 58 | B | A | A |
| 14 | Example | 6.1 | 6.5 | 9.3 | 2.6 | 50 | B | A | A |
| 15 | Example | 4.6 | 12.6 | 12.3 | 3.4 | 40 | B | A | A |
| 16 | Example | 7.2 | 10.4 | 20.5 | 2.3 | 46 | C | B | A |
| 17 | Example | 11.5 | 3.5 | 4.5 | 3.4 | 42 | C | B | A |
| 18 | Example | 8.6 | 4.5 | 6.2 | 0.4 | 60 | C | B | A |
| 19 | Example | 4.9 | 11.6 | 4.8 | 1.2 | 50 | B | A | A |
| 20 | Example | 6.5 | 6.5 | 6.4 | 6.4 | 25 | B | A | A |
| 21 | Example | 3.8 | 9.5 | 4.6 | 9.7 | 6 | B | A | A |
| 22 | Example | 4.2 | 10.7 | 2.9 | 2.8 | 35 | D | C | B |
| 23 | Example | 5.8 | 8.5 | 2.2 | 4.6 | 26 | D | C | B |
| 24 | Example | 4.6 | 6.3 | 3.2 | 3.6 | 28 | D | C | B |
| 25 | Example | 2.9 | — | 6.8 | — | — | D | D | B |

As shown in Tables 3 and 4, it is found that the hydrogen generation efficiency of the thixotropically molded product of each Example is higher than that of the thixotropically molded product of each Comparative Example. In particular, when the CuO powder is used as the metal-containing particles, the hydrogen generation efficiency can be enhanced.

On the other hand, although not shown, when the interposed particles are used as the binder, the mechanical properties of the produced thixotropically molded product can be improved as compared with the case in which a resin is used as the binder.

What is claimed is:

1. A thixotropically molded product that generates hydrogen by contact with an aqueous solution, the thixotropically molded product comprising:
a matrix portion containing Mg as a main component; and
a first particle portion dispersed in the matrix portion and containing, as a main component, any one of Fe, Ni, Co, Cu, and a compound containing at least one of the elements, wherein
an average particle diameter of the first particle portion in a cross section is 30.0 μm or less, and
an area fraction of the first particle portion in the cross section is 0.5% or more and 20.0% or less.

2. The thixotropically molded product according to claim 1, further comprising:
a second particle portion dispersed in the matrix portion and containing Mg₂Si as a main component; and
a third particle portion dispersed in the matrix portion and containing MgO as a main component.

3. The thixotropically molded product according to claim 2, wherein
an average particle diameter of the second particle portion is 10.0 μm or less, and
an average particle diameter of the third particle portion is smaller than the average particle diameter of the second particle portion.

4. A thixotropic molding material used for production of a thixotropically molded product that generates hydrogen by contact with an aqueous solution, the thixotropic molding material comprising:
a metal body containing Mg as a main component;
metal-containing particles adhering to a surface of the metal body and containing, as a main component, any one of Fe, Ni, Co, Cu, and a compound containing at least one of the elements; and
a bonding portion interposed between the metal body and the metal-containing particles, wherein
an average particle diameter of the metal-containing particles is 30 μm or less, and
a ratio of the metal-containing particles to a total of the metal body and the metal-containing particles is 0.5 mass % or more and 30.0 mass % or less.

5. The thixotropic molding material according to claim 4, wherein
the compound is a copper oxide.

6. The thixotropic molding material according to claim 4, wherein
the bonding portion contains interposed particles which are formed of an inorganic material and have an average particle diameter smaller than the average particle diameter of the metal-containing particles, or a resin.

7. The thixotropic molding material according to claim 6, wherein
the inorganic material is a silicon oxide.

8. A method of producing a thixotropic molding material used for production of a thixotropically molded product that generates hydrogen by contact with an aqueous solution, the method comprising:
a preparation step of preparing a mixture containing a metal body containing Mg as a main component, metal-containing particles containing, as a main component, any one of Fe, Ni, Co, Cu, and a compound containing at least one of the elements, a binder, and a dispersion medium;
a stirring step of stirring the mixture; and
a drying step of adhering the metal-containing particles to a surface of the metal body via the binder by removing at least a part of the dispersion medium from the stirred mixture, wherein
an average particle diameter of the metal-containing particles is 30 μm or less, and
in the mixture, a ratio of the metal-containing particles to a total of the metal body and the metal-containing particles is 0.5 mass or more and 30.0 mass or less.
